(19) United States
(12) Patent Application Publication
(10) Pub. No.: US 2024/0309287 A1
(43) Pub. Date: Sep. 19, 2024

(54) AQUEOUS LUBRICANT COMPOSITION FOR METALWORKING

(71) Applicant: TOTALENERGIES ONETECH, COURBEVOIE (FR)

(72) Inventors: Véronique VERROUL, SOLAIZE (FR); Richard FRELECHOUX, SOLAIZE (FR)

(21) Appl. No.: 18/575,563

(22) PCT Filed: Jun. 30, 2022
(86) PCT No.: PCT/EP2022/068164

§ 371 Date: Dec. 29, 2023

(30) Foreign Application Priority Data
Jul. 1, 2021 (FR) FR2107130

(51) Int. Cl. C10M 173/02; B21D 37/18; C10M 145/34; C10M 145/40; C10N 40/20

(52) U.S. Cl. CPC C10M 173/02; B21D 37/18; C10M 145/34; C10M 145/40; C10M 2201/02; C10M 2209/107; C10M 2209/12; C10N 2040/20

(57) ABSTRACT

The invention relates to an aqueous lubricant composition comprising at least: —water; —from 0.1% to 15% by mass of at least one water-soluble polyalkylene glycol; and —from 0.1% to 5% by mass of at least one galactomannan polysaccharide. The invention further relates to the use of such an aqueous lubricant composition as a lubricant in a metalworking process, in particular for reducing, or even preventing, the formation of gummy residues.

### TECHNICAL FIELD

The present invention relates to the field of lubricant compositions, and more particularly to lubricant compositions used in metalworking processes, such as machining operations on metal parts. In particular, the present invention relates to water-based lubricant compositions.

### PRIOR ART

Lubricant compositions, also called “lubricants”, are commonly used in mechanical systems for reducing friction between parts and thus protecting the parts against wear. In addition to wear phenomena, friction can oppose the relative movement of parts that are in contact and induce energy losses that are detrimental to the optimum functioning of the mechanical system.

Lubricants are used in a wide range of applications, from the lubrication of vehicle combustion engines to the lubrication of machines used for machining operations, commonly referred to as metalworking, notably for metal deformation operations.

Metalworking corresponds more generally to the implementation of mechanical or metallurgical processes, which are both diversified and more specialized, and which may be defined as shaping, cutting or joining processes. This may also concern any mechanical transformation of metal, such as machining (turning, milling, drilling, sawing or threading, inter alia), forming, cutting, stamping or rolling.

Metalworking operations most particularly require the use of lubricant compositions, for the purpose of reducing the friction forces between metal parts in contact and preventing premature wear, while at the same time advantageously ensuring cooling of said parts.

These lubricant compositions, dedicated to lubrication in metalworking processes, are also commonly denoted as “metalworking compositions or fluids”, “machining lubricants or fluids” or “cutting lubricants or fluids”.

Conventionally, the lubricant formulations used in such machining operations are lubricants predominantly composed of one or more base oils which are generally combined with additives intended for stimulating the lubricant performance of the base oils, for instance friction-modifying additives.

In general, these lubricant formulations are classified according to the type of oil they incorporate. Thus:
non-renewable mineral fluids are those comprising mineral oils, such as paraffinic, aromatic or naphthenic oils, in their base formulation;
renewable fluids, of plant or animal origin, are those comprising plant oils, animal oils or fats in their base formulation;
mineral fluids of synthetic origin are those comprising mineral oils or chemically modified petrochemical derivatives in their base formulation, for instance poly-alpha-olefins, polyalkylene glycols and hydrogenated mineral oils;
synthetic renewable fluids are those comprising chemically modified plant or animal oils in their base formulation, for instance esters of plant oils, sulfite-based, oxidized or esterified plant oils, or even sulfate-based animal oils.

Certain “mixed” formulations comprise a mixture of the oils listed above in their base formulation. The most commonly known are called semi-synthetic oils and correspond to a mixture of synthetic and mineral oils.

However, the use of oils or greases in metalworking lubricant compositions has several drawbacks. In particular, oil-based lubricants generally have poor resistance to microbial attack, poor cooling properties, and even a negative impact on the working environment, health and safety.

Lubricants in emulsion form, comprising an aqueous phase added to an oily phase, were thus developed. However, these lubricants have poor stability, partly due to water hardness and/or salinity.

In order to solve the problems associated with the use of oil-based lubricant formulations in metalworking applications, water-based compositions have proven to be of certain value.

These formulations generally comprise water, supplemented with various additives in order to ensure the tribological properties required for lubricants, particularly in terms of reducing friction and protecting parts against wear.

As examples, mention may thus be made of WO 2009/106359 and WO 2012/163550, which describe aqueous lubricant compositions notably comprising water and carboxymethylcellulose salts.

Mention may also be made of EP 3 042 946, which proposes an oil-free and emulsifier-free metalworking fluid comprising between 0.1% and 2% by weight of a cellulose-type polymer. Finally, GB 1 272 100 proposes an aqueous metalworking lubricant comprising (1) a linear polypropylene glycol or an ethylene oxide/propylene oxide copolymer with a molecular mass of between 2000 and 9000 Da, and (2) a polyvinylpyrrolidone, a cellulose ether or a triethanolamine phosphate.

Unfortunately, a major drawback of the use of aqueous lubricants for metalworking applications is the formation of so-called “gummy residues”.

These gummy residues are seen after machining operations. Once the machining equipment has stopped, the lubricant, subjected to ambient dehydration, is liable to lead to the formation of salts which, when combined with the polymers present in the lubricant, may form relatively viscous and insoluble residues in the aqueous phase, known as “gummy residues”. Gummy residues adhere to tool walls, and are liable to cause the machining tool to jam, generally necessitating undesirable maintenance of the machine.

Thus, the need remains for an aqueous lubricant composition, for metalworking, which generates little or no gummy residues, while at the same time maintaining, or even improving, the tribological properties of the lubricant, notably in terms of anti-wear and extreme-pressure properties.

The present invention is specifically directed toward meeting this need.

### DISCLOSURE OF THE INVENTION

The present invention thus proposes a novel aqueous lubricant composition with tribological properties, in particular extreme-pressure and anti-wear properties, which are suitable for its use in metalworking, and which leads to little or even no formation of gummy residues after its use in machining equipment.

An aqueous lubricant composition is thus described, in particular for metalworking, comprising at least:
water, preferably osmosed water;
from 0.001% to 80% by mass of at least one polyalkylene glycol; and
from 0.001% to 50% by mass of at least one galactomannan polysaccharide, the percentages being expressed relative to the total mass of the composition.

According to a first of its aspects, the invention relates to an aqueous lubricant composition, in particular for metalworking, comprising at least:
water, preferably osmosed water;
from 0.1% to 15% by mass of at least one water-soluble polyalkylene glycol; and
from 0.1% to 5% by mass of at least one galactomannan polysaccharide, the percentages being expressed relative to the total mass of the composition.

For the purposes of the present invention, the term “aqueous composition” is intended to denote a composition comprising water as the base fluid, in other words as the majority solvent. In particular, water, preferably osmosed water, preferably represents at least 50% by mass of the total mass of the lubricant composition.

In the continuation of the text, the term “aqueous lubricant composition” or “aqueous lubricant” will be used to denote a lubricant composition according to the invention.

For the purposes of the present invention, the term “osmosed water” is intended to denote water which has undergone a purification, notably via a reverse osmosis process, so as to reduce the content of organic and/or mineral compounds, for example to a content of less than 5.0% by weight, preferably less than 1.0% by weight. In the continuation of the text, the terms “demineralized water” or “ultrapure water” will be considered to be equivalent to or synonymous with the term “osmosed water”. In particular, osmosed water may be “deionized water”, in other words water which has undergone a purification so as to reduce the content of ions such as the Ca²⁺ and HCO₃⁻ ions generally present in water. Preferably, a deionized water does not comprise any ions.

Contrary to all expectation, the inventors discovered that the combined use of at least one polyalkylene glycol and at least one galactomannan polysaccharide affords access to an aqueous fluid with excellent tribological properties, which are suitable for its use as a metalworking lubricant, while at the same time leading to very little formation of gummy residues after use.

Thus, as illustrated in the following examples, by supplementing an aqueous lubricant formulation containing at least one polyalkylene glycol with at least one galactomannan polysaccharide, in particular of the guar gum type, it is possible to afford a lubricant fluid which leads to significantly reduced formation of gummy residues.

The propensity of a lubricant formulation to form gummy residues can be evaluated as described in the following examples.

Also described is the use of the combination of at least one polyalkylene glycol and at least one galactomannan polysaccharide, in particular chosen from guar gum and derivatives thereof, in an aqueous lubricant composition, to reduce its propensity to form gummy residues after its use as a metalworking lubricant.

The invention thus relates to the use of the combination of at least one water-soluble polyalkylene glycol and at least one galactomannan polysaccharide, in particular chosen from guar gum and derivatives thereof, in an aqueous lubricant composition, to reduce its propensity to form gummy residues after its use as a metalworking lubricant.

Moreover, the combination of at least one galactomannan polysaccharide does not affect the tribological properties of the lubricant formulation, in particular its friction-reducing performance under extreme-pressure conditions.

The aqueous lubricant composition according to the invention thus displays good anti-wear and extreme-pressure properties, and even, surprisingly, improved anti-wear and/or extreme-pressure properties compared with a composition not comprising any galactomannan polysaccharide according to the invention.

The anti-wear and extreme-pressure properties may be evaluated by an extreme-pressure 4-ball test, in particular according to the standard ASTM D2783, as detailed in the examples below. As demonstrated in the examples, an aqueous lubricant composition according to the invention achieves high weld load values, without any significant increase in wear diameter, thus attesting to its excellent tribological properties.

Thus, the aqueous compositions according to the invention prove to be particularly advantageous for use as metalworking lubricants. They may thus be used as metalworking fluids, for various applications, in replacement for conventionally used lubricants, notably hydrocarbon-based lubricants.

Thus, according to another of its aspects, the invention relates to the use of an aqueous lubricant composition according to the invention, as a lubricant in a metalworking process.

An aqueous composition according to the invention may more particularly be used as a lubricant in any metalworking operation, for example in shaping, cutting or joining processes or any other metal transformation such as forming, stamping, rolling, etc.

It may be intended for use in the working of a wide range of metals, such as aluminum, steel, galvanized steel or even yellow metals.

The invention also relates to a metalworking process using an aqueous lubricant composition according to the invention as a lubricant. In particular, said process comprises a step of applying an aqueous lubricant composition according to the invention to the surface of at least part of the machining tool (or equipment) and/or a metal workpiece.

The lubricant fluid according to the invention advantageously allows friction to be reduced between the machining tool or equipment and the metal workpiece being machined.

The present invention also relates to the use of an aqueous lubricant composition according to the invention for reducing, or even preventing (avoiding), the formation of gummy residues after a metal machining operation using said composition as a lubricant fluid.

The invention more particularly relates to the use of an aqueous lubricant composition according to the invention for reducing friction during a metal machining operation, in particular friction between the machining tool and the metal workpiece, and also for reducing, or even preventing, the appearance of gummy residues after a metal machining operation using said composition as a lubricant fluid.

According to another of its aspects, the invention also relates to a process for lubricating the tool (or equipment) used for a metal machining operation and/or a metal workpiece, comprising at least one step of placing part of the surface of said tool and/or said workpiece in contact with at least one aqueous lubricant composition according to the invention.

Finally, advantageously, a lubricant composition according to the invention, formed mainly of water, has little toxicological impact notably with respect to persons using this lubricant. Advantageously, although water is the majority solvent of an aqueous lubricant according to the invention, the treated surface is correctly lubricated.

Furthermore, the presence of a large proportion of water makes it easier to clean metal surfaces and to remove the lubricant after machining, notably by simply passing over or rinsing with water.

Other features, variants and advantages of an aqueous lubricant composition according to the invention will emerge more clearly on reading the description and the examples that follow, which are given as nonlimiting illustrations of the invention.

The terms “between . . . and . . . ”, “ranging from . . . to . . . ”, “formed from . . . to . . . ” and “varying from . . . to . . . ” should be understood as being limits inclusive, unless otherwise mentioned. In the description and the examples, unless otherwise indicated, the percentages are weight percentages. The percentages are thus expressed on a mass basis relative to the total mass of the composition. The temperature is expressed in degrees Celsius unless otherwise indicated, and the pressure is atmospheric pressure, unless otherwise indicated.

### DETAILED DESCRIPTION

### Aqueous Composition

As mentioned previously, an aqueous lubricant composition according to the invention, also called an aqueous lubricant, is a formulation comprising water as the majority solvent.

For the purposes of the invention, the term “majority solvent” means that water is present in greater amount than any other solvent that may be present in the composition. Preferably, an aqueous lubricant composition according to the invention comprises at least 50% by mass of water, in particular of osmosed water, preferably between 50% and 90% by mass, more preferentially between 60% and 75% by mass, relative to the total mass of the composition. Via its role as a solvent, water allows the polyalkylene glycol(s) and the galactomannan polysaccharide(s) used according to the invention to be dissolved, along with any additives that may be present in the composition, in particular chosen from those detailed in the text hereinbelow.

Advantageously, in addition to its role as a solvent, water affords access to a lubricant composition with good cooling properties, which are useful in the field of metal machining. According to a particular embodiment, the water used in an aqueous lubricant composition according to the invention is deionized water.

Advantageously, a deionized water does not comprise any ions, such as the Ca²⁺ and HCO₃⁻ ions generally present in water, which are responsible for the conduction of electricity in water.

The use of deionized water is thus particularly advantageous in the context of using the aqueous lubricant according to the invention for applications requiring a fluid that conducts little or even no electricity.

An aqueous lubricant composition according to the invention thus differs from hydrocarbon-based lubricants, which comprise a majority proportion of one or more water-insoluble base oils.

The term “water-insoluble oil” is notably intended to denote an oil which does not substantially dissolve in water at room temperature (at about 25° C.). In particular, a water-insoluble oil has a solubility in water of less than 0.2 g/L at room temperature.

This notably concerns lubricant base oils belonging to groups I to V according to the classes defined in the API classification (or their equivalents according to the ATIEL classification) and mixtures thereof.

Preferably, an aqueous lubricant composition according to the present invention comprises less than 20% by mass, preferably less than 10% by mass, in particular less than 5% by mass of water-insoluble base oil(s), relative to the total mass of the composition.

Advantageously, an aqueous lubricant composition according to the invention is totally free of water-insoluble oil.

### Polyalkylene Glycol

As indicated previously, an aqueous lubricant composition according to the invention comprises from 0.1% to 15% by mass of at least one polyalkylene glycol.

It is understood that a lubricant composition according to the invention may comprise a single polyalkylene glycol, or a mixture of at least two different polyalkylene glycols, in particular as described below.

Polyalkylene glycols (referred to as “PAG”) are homopolymers or copolymers consisting of alkylene oxide units.

According to the invention, the polyalkylene glycols are water-soluble.

The term “water soluble” denotes a polyalkylene glycol having a solubility in water of at least 10 g/L, preferably at least 500 g/L, in water at room temperature (about 25° C.).

The polyalkylene glycols may be more particularly formed of C₁-C₄, preferably C₁-C₃, more particularly C₂-C₃ alkylene oxide units.

Advantageously, a polyalkylene glycol used in an aqueous lubricant composition according to the invention comprises at least 50% by mass of propylene oxide and/or ethylene oxide units.

It may be a copolymer, in particular a random copolymer, comprising ethylene oxide, propylene oxide and/or butylene oxide units. Preferably, it may be an ethylene oxide/propylene oxide copolymer, in particular a random copolymer.

Preferably, a polyalkylene glycol used in an aqueous lubricant composition according to the invention has a weight-average molecular mass (Mw) of between 100 and 25 000 g·mol⁻¹, preferably between 5000 and 21 000 g·mol⁻¹.

The number-average molar mass can be measured by gel permeation chromatography (GPC).

Preferably, a polyalkylene glycol used in an aqueous lubricant composition according to the invention has a kinematic viscosity measured at 100° C. (KV100), according to the standard ASTM D445, of between 100 and 5000 mm²/s, in particular between 150 and 3000 mm²/s, for example between 1500 and 3000 mm²/s or between 100 and 250 mm²/s.

Preferably, a polyalkylene glycol used in an aqueous lubricant composition according to the invention has a kinematic viscosity measured at 40° C. (KV40), according to the standard ASTM D445, of between 500 and 30 000 mm²/s, more particularly between 1000 and 25 000 mm²/s, for example between 10 000 and 25 000 mm²/s or between 500 and 2500 mm²/s. The flash point of a polyalkylene glycol used in an aqueous lubricant composition according to the invention is preferably greater than or equal to 160° C., in particular greater than or equal to 220° C., for example between 220° C. and 300° C. The flash point can be measured by means of the standard ISO 2592 or ASTM D92.

Preferably, a polyalkylene glycol used in an aqueous lubricant composition according to the invention has a viscosity index, measured according to the standard ASTM D2270, of between 100 and 800, preferably between 250 and 550.

Such polyalkylene glycols may be commercially available or synthesized according to methods known to those skilled in the art. They may be obtained, for example, by polymerization or copolymerization of alkylene oxides containing between 2 and 4 carbon atoms. An example of synthesis is detailed in US 2012/0108482, by reaction between one or more alcohols containing between 2 and 12 carbon atoms, in particular polyols, such as diols, with alkylene oxides, in particular ethylene oxide, propylene oxide and/or butylene oxide. The alcohol may preferably be a diol, in particular 1,2-propanediol.

As mentioned above, said polyalkylene glycol compound(s) are used in an aqueous lubricant composition according to the invention in a content of between 0.1% and 15% by mass, more preferentially between 1% and 10% by mass, in particular between 2% and 5% by mass, relative to the total mass of the composition.

### Galactomannan Polysaccharide

As indicated previously, an aqueous lubricant composition according to the invention comprises from 0.1% to 5% by mass of at least one galactomannan polysaccharide.

Galactomannan polysaccharides are heterogeneous polysaccharides consisting of galactose and mannose units. These nonionic polyosides may be extracted from the albumen of legume seeds, of which they constitute the storage carbohydrate.

More particularly, they are macromolecules consisting of a main chain of β(1,4)-linked D-mannopyranose units, bearing side branches consisting of a single D-galactopyranose unit α(1,6)-linked to the main chain. The various galactomannans can be distinguished firstly by the proportion of α-D-galactopyranose units present in the polymer, and secondly by differences in terms of the distribution of the galactose units along the mannose chain.

The mannose/galactose (M/G) ratio is of the order of 2 for guar gum, 3 for tara gum and 4 for locust bean gum.

Galactomannan polysaccharides may more particularly have the following chemical structure:

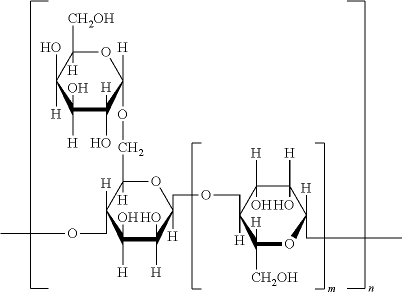

where, for example, m is 1 (guar gum), 2 (tara gum) or 3 (locust bean gum).

The galactomannan polysaccharides may in particular be chosen from guar gum, locust bean gum, tara gum and derivatives thereof.

The term “derivatives” more particularly refers to chemically modified nonionic gums, or else to cationic or anionic gums.

According to a particular embodiment, a lubricant composition according to the invention comprises at least one galactomannan polysaccharide of the guar gum type. The term “guar gum type” is intended to denote guar gum and derivatives thereof, in particular chosen from chemically modified nonionic guar gums, and cationic or anionic guar gums.

Thus, according to a preferred embodiment, a lubricant composition according to the invention comprises at least one galactomannan polysaccharide of the guar gum type chosen from guar gum, chemically modified nonionic guar gums, and cationic or anionic guar gums. Guar gum is characterized by a mannose:galactose ratio of the order of 2:1. The galactose group is regularly distributed along the mannose chain.

It is understood that a lubricant composition according to the invention may comprise a single galactomannan polysaccharide, in particular of the guar gum type, or even a mixture of at least two different galactomannan polysaccharides, for example a mixture of at least two galactomannan polysaccharides chosen from guar gum and derivatives thereof.

Galactomannan polysaccharides of the guar gum type may be nonionic guar gums, which are either unmodified or chemically modified.

The modified nonionic guar gums that may be used according to the invention may more particularly be guar gums modified with C₁-C₆ hydroxyalkyl groups, among which, examples that may be mentioned include hydroxymethyl, hydroxyethyl, hydroxypropyl and hydroxybutyl groups. By way of example, a chemically modified nonionic guar gum used in a lubricant composition according to the invention may be hydroxypropyl guar.

The galactomannan polysaccharides, for example of the guar gum type, may also be cationic galactomannans, in particular with a cationic charge density of less than or equal to 1.5 meq/g and more particularly between 0.1 and 1 meq/g. The charge density may be determined according to the Kjeldahl method. It generally corresponds to a pH of the order of 3 to 9. In general, a cationic galactomannan polysaccharide comprises cationic groups and/or groups that may be ionized to cationic groups.

Preferred cationic groups are chosen from those including primary, secondary, tertiary and/or quaternary amine groups.

The cationic galactomannan polysaccharides generally have a weight-average molecular mass of between 500 and 5×10⁶ approximately and preferably between 10³ and 3×10⁶ approximately.

For example, it may be a galactomannan polysaccharide including tri(C₁-C₄)alkylammonium cationic groups. Preferably, 2% to 30% by number of the hydroxyl functions of the galactomannan polysaccharide bear trialkylammonium cationic groups.

Among these trialkylammonium groups, mention may be made most particularly of trimethylammonium and triethylammonium groups.

Even more preferentially, these groups represent from 5% to 20% by weight relative to the total weight of the modified galactomannan polysaccharide.

The galactomannan polysaccharides of the guar gum type may thus be cationic guar gums, in particular including hydroxypropyl trimethylammonium groups. They may be obtained, for example, by reacting guar gum with 2,3-epoxypropyl trimethylammonium chloride.

By way of example, a cationic guar gum used in a lubricant composition according to the invention may be guar hydroxypropyl trimonium chloride.

The galactomannan polysaccharides, for example of the guar gum type, may also be anionic galactomannans. In particular, they may be galactomannan polysaccharides including groups derived from carboxylic, sulfonic, sulfenic, phosphoric, phosphonic or pyruvic acid. Preferably, the anionic group is a carboxylic acid group. The anionic group may also be in the form of an acid salt, notably a sodium, calcium, lithium or potassium salt.

The galactomannan polysaccharides of the guar gum type may thus be carboxymethylated guar gums, such as carboxymethyl guar or carboxymethyl hydroxypropyl guar.

By way of example, an anionic guar gum used in a lubricant composition according to the invention may be carboxymethyl hydroxypropyl guar.

Preferably, said galactomannan polysaccharide(s) used in a lubricant composition according to the invention are chosen from guar gum, guar gum derivatives, and mixtures thereof, in particular from guar gum, hydroxypropyl guar, carboxymethyl hydroxypropyl guar, guar hydroxypropyl trimonium chloride, and mixtures thereof.

According to a particular embodiment, a lubricant composition according to the invention uses, as galactomannan polysaccharide, at least hydroxypropyl guar.

As mentioned previously, said galactomannan polysaccharide(s), preferably of the guar gum type, are used in an aqueous lubricant composition according to the invention in a content of between 0.1% and 5% by mass, more preferentially between 0.1% and 3.5% by mass, in particular between 0.2% and 1% by mass, relative to the total mass of the composition.

### Additives

An aqueous lubricant composition according to the invention may also comprise various additives.

It is understood that said additive(s) are compatible with their use in an aqueous medium. Advantageously, the additives are used in a water-soluble or water-emulsifiable form, for example in the form of salts or ionic liquids.

Needless to say, said additive(s) are chosen with regard to the intended application of the aqueous lubricant.

Needless to say, a person skilled in the art will take care to select the optional additives and/or the amount thereof such that the advantageous properties of the aqueous lubricant composition according to the invention, in particular the advantageous effect of reducing gummy residues after the lubricant composition has been used for metalworking, and the tribological properties, in particular the extreme-pressure properties and the protection of parts against wear, are not adversely affected by the envisaged addition.

Such additives may be chosen more particularly from antifoaming agents, biocides, pH regulators, corrosion inhibitors, antiwear and/or extreme-pressure additives, sequestrants, metal passivating agents, dyes, dispersants, emulsifying agents, wetting agents, and mixtures thereof.

Advantageously, an aqueous lubricant composition according to the invention may comprise one or more additives chosen from antifoaming agents, biocides, pH regulators, corrosion inhibitors, sequestrants, metal passivating agents, emulsifiers, and mixtures thereof.

An aqueous lubricant composition according to the invention may more particularly comprise from 1% to 49.8% by mass of additives, in particular from 5% to 40% by mass of additives, relative to the total mass of the composition.

### Corrosion Inhibitor

An aqueous lubricant composition according to the invention may comprise at least one corrosion inhibitor. Corrosion inhibitors advantageously make it possible to reduce or even prevent the corrosion of metal parts. The nature of the corrosion inhibitor(s) can be chosen with regard to the metal to be protected against corrosion, such as aluminum, steel, galvanized steel, or yellow metals, for example copper or brass.

Among the inorganic corrosion inhibitors that may be mentioned are sodium, potassium, calcium or magnesium nitrites, sulfites, silicates, borates or phosphates, alkali metal phosphates, and zinc, magnesium or nickel hydroxides, molybdates or sulfates.

Among the organic corrosion inhibitors, mention may be made of aliphatic monocarboxylic acids, in particular containing from 4 to 15 carbon atoms, for example octanoic acid, aliphatic dicarboxylic acids containing from 4 to 15 carbon atoms, for example decanedioic acid (sebacic acid), undecanedioic acid, dodecanedioic acid, isononanoic acid or mixtures thereof, polycarboxylic acids optionally neutralized with triethanolamine, such as 1,3,5-triazine-2,4,6-tris(6-aminocaproic acid), alkanoylamidocarboxylic acids, in particular isononanoylamidocaproic acid, 6-[[(4-methylphenyl)sulfonyl]amino]hexanoic acid, and mixtures thereof. Borate-based amides, produced by the reaction of amines or amino alcohols with boric acid, may also be used.

An aqueous lubricant composition according to the invention may notably comprise from 0.01% to 15% by mass of corrosion inhibitor(s), preferably from 1.0% to 13% by mass, relative to the total mass of the composition.

### Antiwear/Extreme-Pressure Additive

An aqueous lubricant composition according to the invention may comprise at least one antiwear and/or extreme-pressure additive. Their function is to reduce wear and the coefficient of friction, or to prevent metal-to-metal contact by forming a protective film adsorbed onto these surfaces.

An aqueous lubricant composition according to the invention may comprise between 0.001% and 50% by mass of antiwear and/or extreme-pressure additive(s), in particular of sulfur-based fatty acid(s), as defined above, preferably between 0.2% and 5% by mass, relative to the total mass of the composition.

Advantageously, a composition according to the invention, combining at least one polyalkylene glycol and at least one galactomannan polysaccharide, in particular of the guar gum type, has good anti-wear and extreme-pressure properties, even in the absence of ancillary anti-wear and/or extreme-pressure additives.

Thus, according to a particular embodiment, a lubricant composition according to the invention comprises less than 1% by mass of anti-wear and/or extreme-pressure additives, in particular less than 0.5% by mass, notably less than 0.1% by mass of anti-wear and/or extreme-pressure additives, or is even free of anti-wear and/or extreme-pressure additives.

### Antifoaming Agent

An aqueous lubricant composition according to the invention may comprise at least one antifoaming additive. Antifoaming agents make it possible to prevent foaming of the lubricant fluid.

This may be, for example, an antifoaming agent based on polysiloxanes or acrylate polymers. Preferably, the antifoaming agent is chosen from three-dimensional siloxanes.

Also, the antifoaming agents may be polar polymers such as polymethylsiloxanes or polyacrylates.

In particular, an aqueous lubricant composition according to the invention may comprise from 0.001% to 3.0% by mass of antifoam additive(s), preferably from 0.005% to 1.5% by mass, relative to the total mass of the lubricant composition.

### pH Regulator

An aqueous lubricant composition according to the invention may comprise at least one pH-regulating additive, in particular an alkaline buffer. The pH regulator makes it possible to maintain the desired pH of the lubricant composition, in particular so as to preserve an alkaline pH, advantageously between 8 and 11, notably so as to prevent corrosion of metal surfaces.

The pH regulator may be chosen from the family of amines, in particular alkanolamines and amino alcohols.

It may notably be a pH-regulating additive chosen from ethanolamines, such as monoethanolamine (MEA), diethanolamine (DEA), triethanolamine (TEA), diglycolamine (DGA), isopropanolamines, such as monoisopropanolamine (MIPA), diisopropanolamine (DIPA) and triisopropanolamine (TIPA), ethylene amines, such as ethylenediamine (EDA), diethylenetriamine (DETA), triethylenetetramine (TETA) and tetraethylenepentamine (TEPA), alkanolamines, such as methyldiethanolamine (MDEA), cyclamines, such as cyclohexylamine, 2-amino-2-ethyl-1,3-propanediol, 2-amino-2-methyl-1-propanol and mixtures thereof.

An aqueous lubricant composition according to the invention may notably comprise from 1% to 25% by mass of pH-regulating additive(s), preferably from 5% to 20% by mass, relative to the total mass of the composition.

### Metal Passivating Agents

An aqueous lubricant composition according to the invention may comprise at least one metal passivating agent. Metal passivating agents make it possible to protect metal parts by promoting the formation of metal oxide on their surface.

The metal passivating agents may be chosen, for example, from triazole derivatives, such as tetrahydrobenzotriazole (THBTZ), tolyltriazole (TTZ), benzotriazole (BTZ), amines substituted with a triazole group, such as N,N-bis(2-ethylhexyl)-1,2,4-triazol-1-ylmethanamine, N′-bis(2-ethylhexyl)-4-methyl-1H-benzotriazol-1-methylamine, N,N-bis(heptyl)-ar-methyl-1H-benzotriazole-1-methanamine, N,N-bis(nonyl)-ar-methyl-1H-benzotriazole-1-methanamine, N,N-bis(decyl)-ar-methyl-1H-benzotriazole-1-methanamine, N,N-bis(undecyl)-ar-methyl-1H-benzotriazole-1-methanamine, N,N-bis(dodecyl)-ar-methyl-1H-benzotriazole-1-methanamine N,N-bis(2-ethylhexyl)-ar-methyl-1H-benzotriazole-1-methanamine, 1,2,4-triazoles, benzimidazoles, 2-alkyldithiobenzimidazoles, 2-alkyldithiobenzothiazoles, 2-(N,N-dialkyldithiocarbamoyl)benzothiazoles, 2,5-bis(alkyldithio)-1,3,4-thiadiazoles, such as 2,5-bis(tert-octyldithio)-1,3,4-thiadiazole, 2,5-bis(tert-nonyldithio)-1,3,4-thiadiazole, 2,5-bis(tert-decyldithio)-1,3,4-thiadiazole, 2,5-bis(tert-undecyldithio)-1,3,4-thiadiazole, 2,5-bis(tert-dodecyldithio)-1,3,4-thiadiazole, 2,5-bis(tert-tridecyldithio)-1,3,4-thiadiazole, 2,5-bis(tert-tetradecyldithio)-1,3,4-thiadiazole, 2,5-bis(tert-pentadecyldithio)-1,3,4-thiadiazole, 2,5-bis(tert-hexadecyldithio)-1,3,4-thiadiazole, 2,5-bis(tert-heptadecyldithio)-1,3,4-thiadiazole, 2,5-bis(tert-octadecyldithio)-1,3,4-thiadiazole, 2,5-bis(tert-nonadecyldithio)-1,3,4-thiadiazole, 2,5-bis(tert-eicosyldithio)-1,3,4-thiadiazole, 2,5-bis(N,N-dialkyldithiocarbamoyl)-1,3,4-thiadiazoles, 2-alkyldithio-5-mercaptothiadiazoles, and mixtures thereof.

Preferably, the metal passivating agents are chosen from tetrahydrobenzotriazole (THBTZ), tolyltriazole (TTZ), benzotriazole (BTZ), and salts thereof, taken alone or as mixtures.

An aqueous lubricant composition according to the invention may notably comprise from 0.01% to 2.0% by mass of metal passivating agent(s), preferably from 0.1% to 1.0% by mass, more preferentially from 0.2% to 0.8% by mass, relative to the total mass of the composition.

### Dyes

An aqueous lubricant composition according to the invention may comprise one or more dyes. The dyes may be natural or synthetic, generally organic.

The dyes that may be used in an aqueous lubricant composition may be chosen more particularly from natural or synthetic water-soluble dyes, for example the dyes FDC Red 4, DC Red 6, DC Red 22, DC Red 28, DC Red 30, DC Red 33, DC Orange 4, DC Yellow 5, DC Yellow 6, DC Yellow 8, FDC Green 3, DC Green 5, FDC Blue 1, betanine (beetroot), carmine, a chlorophylline, methylene blue, anthocyans (enocianin, black carrot and hibiscus), caramel and riboflavin.

An aqueous lubricant composition according to the invention may comprise between 0.01% and 2.0% by mass of dye(s), preferably between 0.01% and 1.5% by mass, more preferentially between 0.02% and 1.0% by mass, relative to the total mass of the composition.

### Emulsifying Agents

An aqueous lubricant composition according to the invention may comprise one or more emulsifying agents, also called emulgators. Their function is to generate stable emulsions in water.

The emulsifying agents may more particularly be nonionic, for instance ethoxylated fatty alcohols, ethoxylated fatty acids, compounds resulting from the reaction between propylene oxide, ethylenediamine and optionally ethylene oxide, ethoxylated fatty amides; anionic, for example KOH or NaOH soaps; sulfonates; cationic, such as quaternary ammonium compounds; or water-soluble or water-emulsifiable carboxylic acid esters.

In particular, an aqueous lubricant composition according to the invention may comprise from 0.01% to 10% by mass of emulsifying agent(s), preferably from 0.1% to 5.0% by mass, relative to the total mass of the lubricant composition.

### Sequestrants

An aqueous lubricant composition according to the invention may comprise at least one sequestrant. Sequestrants, also called chelating agents, make it possible to limit the incrustation of metal ions into the composition.

As examples of sequestrants, mention may be made of phosphonic acid and phosphonate derivatives, such as diethylenetriaminepentamethylphosphonic acid (DTPMPA), aminotri(methylenephosphonic acid) (ATMP), hydroxyethanediphosphonic acid (HEDP), 1-hydroxyethylidene 1,1-diphosphonate, 2-hydroxyethylaminedi(methylenephosphonic acid) (HEAMBP), diethylenetriaminepenta(methylenephosphonic acid) (DTMP), multifunctional organic acids and hydroxylated acids, such as ethylenediaminetetraacetic acid (EDTA), pteroyl-L-glutamic acid (PGLU), organic polyacids, such as maleic acid and polyaspartic acid, polysaccharides other than the galactomannan polysaccharides defined above, and carbohydrates, such as inulin, carboxymethylinulin and carboxymethylchitosan. An aqueous lubricant composition according to the invention may comprise from 0.001% to 2.0% by mass of sequestrant(s), preferably from 0.01% to 1.0% by mass, relative to the total mass of the composition.

### Biocides

An aqueous lubricant composition according to the invention may comprise at least one biocidal and/or fungicidal and/or bactericidal agent. The biocides may be used to improve the biological stability of the composition by limiting the growth of bacteria, fungi and yeasts in the lubricant fluid.

Such biocides may be chosen from parabens, aldehydes, reactive acetylacetone compounds, isothiazolinones, phenolic compounds, acid salts, halogenated compounds, quaternary ammoniums, certain alcohols and mixtures thereof.

Preferably, the biocides may be chosen from optionally substituted benzisothiazolinones (BIT), such as N-butyl-1,2-benzisothiazolin-3-one, methylisothiazolinones (MIT), mixtures of methylisothiazolinone and chloromethylisothiazolinone (MIT/CMIT), ortho-phenylphenol (OPP) or its sodium salt, 3-iodo-2-propynylbutyl carbamate (IPBC), chlorocresol and N,N-methylenebismorpholine (MBM); sorbic acid; preferably from ortho-phenylphenol (OPP) or its sodium salt, 3-iodo-2-propynylbutyl carbamate, chlorocresol, benzisothiazolinones and N,N-methyleneisomorpholine.

An aqueous lubricant composition according to the invention may notably comprise between 0.01% and 10% by mass of biocide(s), preferably between 0.1% and 5.0% by mass, relative to the total mass of the composition.

According to a particular embodiment, an aqueous lubricant composition according to the invention comprises:
at least 50% by mass of water, preferably osmosed water;
from 0.1% to 15% by mass of at least one water-soluble polyalkylene glycol in particular as defined previously;
from 0.1% to 5% by mass of at least one galactomannan polysaccharide, preferably chosen from guar gum and derivatives thereof, in particular hydroxypropyl guar; and
optionally from 1% to 50% by mass, in particular from 5% to 40% by mass, of one or more additives chosen from antifoaming agents, biocides, pH regulators, corrosion inhibitors, sequestrants, metal passivating agents, emulsifying agents, and mixtures thereof, the contents being expressed relative to the total mass of the lubricant composition.

In particular, an aqueous lubricant composition according to the invention may consist of:
from 0.1% to 15% by mass of at least one water-soluble polyalkylene glycol in particular as defined previously;
from 0.1% to 5% by mass of at least one galactomannan polysaccharide, preferably chosen from guar gum and derivatives thereof, in particular hydroxypropyl guar; and
optionally from 1% to 50% by mass, in particular from 5% to 40% by mass, of one or more additives chosen from antifoaming agents, biocides, pH regulators, corrosion inhibitors, sequestrants, metal passivating agents, emulsifying agents, and mixtures thereof, the contents being expressed relative to the total mass of the lubricant composition, and the remainder being water, preferably osmosed water.

According to the invention, the particular, advantageous or preferred features of the composition according to the invention make it possible to define uses according to the invention that are also particular, advantageous or preferred.

The invention will now be described by means of the examples that follow, which are, needless to say, given as nonlimiting illustrations of the invention.

### EXAMPLE

### Evaluation of the Tribological Properties

The extreme-pressure and anti-wear properties of the lubricant compositions are evaluated by the 4-ball test according to the standard ASTM D2783, adapted on the basis of the following parameters:
speed close to 1500 rpm,
room temperature, i.e. about 20° C.,
load duration of 1 minute.

The extreme-pressure measurement is performed by rotating a stainless steel ball on three other stainless steel balls held stationary, the four balls being completely covered with a lubricant film. A load is applied to the balls and gradually increased (every minute according to the above parameters) until the balls weld together. The balls are changed before each load increase.

The extreme-pressure capacity corresponds to the load value at and above which the four balls weld together, preventing the top ball from rotating on the other three. The higher the load, the higher the extreme-pressure capacity.

This method also allows the anti-wear properties of a lubricant composition to be evaluated. As the load is gradually increased, the wear diameter on the three balls can be determined at each load level. The smaller the wear diameter, the more effective the lubricant in preventing wear (or seizure) of the parts.

The wear diameter values given in the following examples are those obtained for the load value preceding welding of the balls.

It is common practice to dilute the compositions before performing the load tests, and the dilution rate is thus specified in the results below.

### Measurement of Gummy Residue Formation

The test for evaluating gummy residue formation is taken from the standard ISO/TS 12-927 part B.6, for which the time and temperature parameters have been adapted.

Said standard allows simulation of the residual gummy tack aspect of a product. Thus, this test makes it possible to evaluate whether a product remaining on the machine at standstill after machining, for example left in the open air, will be prone to cause blocking on restarting the machine, due to the presence of dried, tacky residues on the tooling.

The formation of gummy residues is quantified by measuring the mass of water-insoluble residues after use of the composition.

To do this, the test composition is placed in a ventilated oven at a temperature of 90° C. for 20 hours. The mass of composition is measured before and after passing through the oven. The composition is then dissolved in osmosed water for 15 minutes at room temperature, with mechanical stirring at a speed of 600 rpm. The insoluble residues correspond to the gummy residues formed. These residues are filtered off and weighed to determine their amount in milligrams. The larger the amount of residue, the greater the tendency of the lubricant composition to form undesirable gummy residues after use as a lubricant in machining equipment.

### Example 1: Preparation of the Lubricant Compositions

An aqueous lubricant composition according to the invention (I1) and a comparative aqueous lubricant composition (C1), not comprising any galactomannan polysaccharides, were formulated according to the protocol below, in the mass percentages indicated in Table 1 below.

The formulation protocol is as follows:

The galactomannan polysaccharide is dissolved in osmosed water. The solution is stirred for 30 minutes at room temperature (in the region of 20° C.). At this stage, the solution may not be clear.

The remaining components are then added as follows: introduction of the pH regulating additive(s), then of the corrosion inhibiting additive(s), while heating the mixture at a temperature of 40 to 50° C. The solution is stirred using a magnetic bar for a time ranging from 1 to 1.5 hours. The following compounds are then added, sequentially every 5 minutes, in the following order and with continued stirring: passivator(s), sequestrant(s), PAG, and then optionally wetting agent(s), antifoaming agent(s) and biocidal agent(s).

Final stirring lasting 1 hour is then performed.

TABLE 1

| | I1 according to | |
|---|---|---|
| Composition | the invention | C1 comparative |
| Osmosed water [%] | 67.61 | 68.01 |
| Polyalkylene glycol 1 [%] | 3 | 3 |
| Hydroxypropyl guar [%] | 0.40 | — |
| Additive(s)⁽¹⁾ | 28.99 | 28.99 |

### Example 2: Characterization of the Compositions According to the Invention and Comparative Compositions

The tribological properties were measured for each composition, as detailed in the above protocol.

The results are collated in Table 2 below.

TABLE 2

| | Dilution | Welding | Wear |
|---|---|---|---|
| Composition | rate [%] | load [kg] | diamater [mm] |
| I1 (invention) | 10 | 180 | 1.3-1.4 |
| C1 (comparative) | 10 | 180 | 1.9-2.0 |

Composition I1 according to the invention has a weld load equivalent to that obtained for the comparative composition, and a significantly smaller wear diameter.

Thus, the lubricant compositions in accordance with the invention, incorporating at least one galactomannan polysaccharide, such as guar gum, in combination with at least one polyalkylene glycol, display excellent extreme-pressure and anti-wear properties, equivalent to, or even improved relative to, those obtained with a composition not using any galactomannan polysaccharide.

Moreover, the gummy residues were quantified for each of the compositions, and the results are given in Table 3 below.

TABLE 3

| | Variation in mass | Mass of water- |
|---|---|---|
| | after passing | insoluble matter |
| Composition | through the oven [%] | [mg] |
| I1 (invention) | 98.6 | 6.4 |
| C1 (comparative) | 98.8 | 14.3 |

Composition I1 according to the invention has a significantly reduced mass of insoluble compounds, corresponding to gummy residues, compared with that obtained for composition C1.

Thus, the lubricant compositions in accordance with the invention, incorporating at least one galactomannan polysaccharide, such as guar gum, in combination with at least one polyalkylene glycol, advantageously make it possible to lead to low amounts of gummy residues after their use in machining equipment.

### Example 3: Preparation of Compositions According to the Invention

Two aqueous lubricant compositions according to the invention (I3, I4), were formulated according to the same formulation protocol as described in Example 1, with the mass percentages indicated in Table 4 below.

TABLE 4

| | I2 according to | I3 according to |
|---|---|---|
| Composition | the invention | the invention |
| Osmosed water [%] | 67.61 | 67.61 |
| Polyalkylene glycol 2 [%] | 3 | 3 |
| Hydroxypropyl guar [%] | 0.40 | — |
| Hydroxypropyl guar and | — | 0.40 |
| hydroxypropyl trimonium | | |
| guar chloride [%] | | |
| Additive(s)⁽¹⁾ | 28.99 | 28.99 |

### Example 4: Characterization of the Compositions According to the Invention

The tribological properties were measured for each composition, as detailed in the above protocol.

The results are collated in Table 5 below.

TABLE 5

| | Dilution | Welding | Wear |
|---|---|---|---|
| Composition | rate [%] | load [kg] | diamater [mm] |
| I2 (invention) | 10 | 200 | 1.7-1.8 |
| I3 (invention) | 10 | 180 | 1.3-1.4 |

Compositions I2 and I3 in accordance with the invention display excellent tribological properties.

Moreover, the gummy residues were quantified for each composition, and the results are given in Table 6 below.

TABLE 6

| | Variation in mass after | Mass of water-insoluble |
|---|---|---|
| Composition | passing through the oven [%] | matter [mg] |
| I2 (invention) | 99.0 | 9.9 |
| I3 (invention) | 99.0 | 7.4 |

Compositions I2 and I3, in accordance with the invention, form small amounts of gummy residues after use.

1-10. (canceled)

11. An aqueous lubricant composition for metalworking comprising, based on a total weight of the composition:
water;
from 0.1% to 15% by weight of at least one polyalkylene glycol; and
from 0.1% to 5% by weight of at least one galactomannan polysaccharide.

12. The aqueous lubricant composition of claim 11, comprising from 50% to 90% by weight of osmosed water.

13. The aqueous lubricant composition of claim 11, comprising from 60% to 75% by weight of osmosed water.

14. The aqueous lubricant composition of claim 11, wherein the at least one polyalkylene glycol is chosen from copolymers comprising ethylene oxide, propylene oxide and/or butylene oxide monomers.

15. The aqueous lubricant composition of claim 11, comprising from 1% to 10% by weight of the at least one polyalkylene glycol.

16. The aqueous lubricant composition of claim 11, comprising from 2% to 5% by weight of the at least one polyalkylene glycol.

17. The aqueous lubricant composition of claim 11, wherein the at least one galactomannan polysaccharide is chosen from guar gum, guar gum derivatives, or mixtures thereof.

18. The aqueous lubricant composition of claim 11, comprising from 0.1% to 3.5% by weight of the at least one galactomannan polysaccharide.

19. The aqueous lubricant composition of claim 11, comprising from 0.2% to 1% by weight of the at least one galactomannan polysaccharide.

20. The aqueous lubricant composition of claim 11, further comprising at least one additive chosen from antifoaming agents, biocides, pH regulators, corrosion inhibitors, antiwear and/or extreme-pressure additives, sequestrants, metal passivating agents, dyes, dispersants, emulsifying agents, wetting agents, or mixtures thereof.

21. A method of forming a metal part, comprising:
applying an aqueous lubricant composition to a metal workpiece and/or a machining tool; and
machining the metal workpiece using machining apparatus to form a metal part, such that the aqueous lubricant composition reduces friction during the machining,
wherein the aqueous lubricant composition comprises, based on a total weight of the composition:
water;
from 0.1% to 15% by weight of at least one polyalkylene glycol; and
from 0.1% to 5% by weight of at least one galactomannan polysaccharide,
the percentages being expressed relative to the total weight of the composition.

22. The method of claim 21, wherein the aqueous lubricant composition comprises:
from 60% to 75% by weight of osmosed water;
from 2% to 5% by weight of at least one polyalkylene glycol; and
from 0.2% to 1% by weight of at least one guar gum or derivatives thereof.
